(19) United States
(12) Patent Application Publication
(10) Pub. No.: US 2012/0105200 A1
(43) Pub. Date: May 3, 2012

(54) PORTABLE SENSOR APPARATUS AND BIOMETRIC RECOGNITION-BASED SERVICE SYSTEM HAVING THE SAME

(75) Inventors: Jang Hee Yoo, Daejeon (KR); Ki Young Moon, Daejeon (KR); Su Young Chi, Daejeon (KR)

(73) Assignee: Electronics and Telecommunications Research Institute, Daejeon (KR)

(21) Appl. No.: 13/188,917

(22) Filed: Jul. 22, 2011

(30) Foreign Application Priority Data
Nov. 1, 2010 (KR) 10-2010-0107811

(51) Int. Cl. G06F 7/00

(52) U.S. Cl. 340/5.82

(57) ABSTRACT

A portable sensor apparatus allowing a mobile device to obtain biometric recognition data required for providing various services without changing the structure and size of the mobile device, and a biometric recognition-based service system having the same are provided. The portable sensor apparatus interworking with a mobile device through a short-distance wireless network includes: a sensor unit acquiring biometric recognition data; a short-distance wireless communications unit providing the biometric recognition data to the mobile device through the short-distance wireless network or receiving a request from the mobile device; a microprocessor commanding to acquire the biometric recognition data in response to a request from the mobile device or a user request; and a user interaction unit receiving the user request or displaying an operational state of the portable sensor apparatus.

### CROSS-REFERENCE TO RELATED APPLICATIONS

This application claims the priority of Korean Patent Application No. 10-2010-0107811 filed on Nov. 1, 2010, in the Korean Intellectual Property Office, the disclosure of which is incorporated herein by reference.

### BACKGROUND OF THE INVENTION

1. Field of the Invention

The present invention relates to a portable sensor apparatus allowing a mobile device to obtain biometric recognition data required for providing various services without changing the structure or size of the mobile device, and a biometric recognition-based service system having the same.

2. Description of the Related Art

Recently, various types of high specification mobile devices such as smartphones, mobile phones, PDAs (personal digital assistants), and the like, are rapidly proliferating. These mobile devices are required to provide effective, varied services by interworking with various other devices.

In particular, in the case of smartphones, the development of a new technique for providing biometric recognition-based security application services and medical services is required.

However, the most critical factor of mobile devices is portability, such that when a biometric recognition data obtaining sensor is installed in a mobile device, many problems related to changes in the structure and size of the mobile device may arise.

### SUMMARY OF THE INVENTION

An aspect of the present invention provides a portable sensor apparatus providing biometric recognition data through a communications scheme, such as Bluetooth, WiFi, Infrared Data Association (IrDA), or the like, to allow a mobile device to acquire the biometric recognition data required for providing services without having to change its internal structure and size.

Another aspect of the present invention provides a biometric recognition-based service system implemented by including the portable sensor apparatus.

According to an aspect of the present invention, there is provided a portable sensor apparatus interworking with a mobile device through a short-distance wireless network, including: a sensor unit acquiring biometric recognition data; a short-distance wireless communications unit providing the biometric recognition data to the mobile device through the short-distance wireless network or receiving a request from the mobile device; a microprocessor commanding to acquire the biometric recognition data in response to a request from the mobile device or a user request; and a user interaction unit receiving the user request or displaying an operational state of the portable sensor apparatus.

The short-distance wireless network may use a communications scheme, such as Bluetooth, WiFi, and Infrared Data Association (IrDA).

When Bluetooth and WiFi communications scheme are employed, the short-distance wireless communications unit may encrypt both communications channel and raw data.

When IrDA scheme is employed, the short-distance wireless communications unit may encrypt the raw data.

The sensor unit may include: a sensor acquiring and providing the biometric recognition data; and a data acquiring unit uniformly maintaining the quality of the biometric recognition data acquired by the sensor by controlling the operation of the sensor.

The data acquiring unit may further include a function of storing the biometric recognition data acquired by the sensor.

The portable sensor apparatus may further include: a power supply unit supplying driving power of the portable sensor apparatus and indicating a charged/discharged state of the driving power.

The user interaction unit may include: an input unit detecting and receiving the user request; and an output unit informing the user about an operational state of the portable sensor apparatus.

According to an aspect of the present invention, there is provided a biometric recognition-based service system including: a mobile device providing a service using biometric recognition data; and a portable sensor apparatus implemented as an independent device of the mobile device, acquiring the biometric recognition data, and providing the acquired biometric recognition data to the mobile device through a short-distance wireless network.

The short-distance wireless network may use a communications scheme, such as Bluetooth, WiFi, and Infrared Data Association (IrDA).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating the configuration of a biometric recognition-based service system according to an exemplary embodiment of the present invention;

FIG. 2 is a schematic block diagram of a portable sensor apparatus according to an exemplary embodiment of the present invention; and

FIG. 3 is a flow chart illustrating the process of a method for providing biometric recognition data using a short-distance wireless network according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

Unless explicitly described to the contrary, the word “comprise” and variations such as “comprises” or “comprising,” will be understood to imply the inclusion of stated elements but not the exclusion of any other elements.

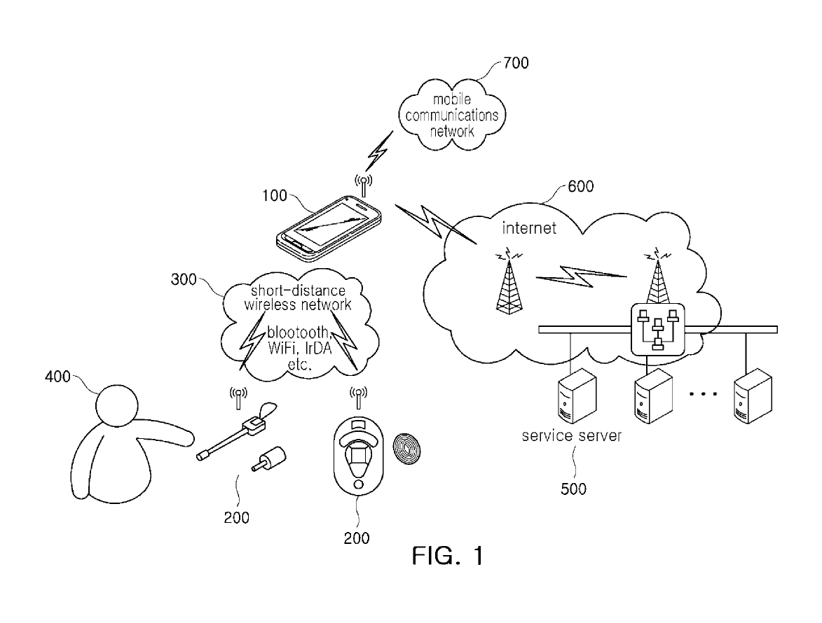

FIG. 1 is a view illustrating the configuration of a biometric recognition-based service system according to an exemplary embodiment of the present invention.

With reference to FIG. 1, the service system includes a mobile device 100 and a portable sensor apparatus 200 implemented in the form of an independent apparatus separated from the mobile device 100. The portable sensor apparatus 200 and the mobile device 100 interwork through a short-distance wireless network 300 using a communications scheme such as Bluetooth, WiFi, Infrared Data Association (IrDA), or the like.

The mobile device 100 may be implemented as a smartphone, a mobile phone, a PDA (Personal Digital Assistant), a PMP (Portable Multimedia Player), or the like, basically providing a wireless communications function for the Bluetooth, WiFi, Infrared Data Association (IrDA) communications scheme, or the like.

An application program for providing a biometric recognition-based service is installed in the mobile device 100. Also, the mobile device 100 may be implemented to interwork with a service server 500 to provide a biometric recognition-based service.

The portable sensor apparatus 200 is implemented in the form of an independent apparatus separated from the mobile device 100 and has a sensor function of acquiring biometric data having biometric information of a user 400 such as a fingerprint, an iris image, a vein pattern, or the like, and a function of stably providing the acquired biometric recognition data through a wireless communications function such as Bluetooth, WiFi, Infrared Data Association (IrDA), or the like.

Thus, by simply installing an application program in the mobile device 100 according to an exemplary embodiment of the present invention without changing the internal structure and size of the mobile device 100, the mobile device 100 can acquire biometric recognition data required for providing a biometric recognition-based service through communications with the portable sensor apparatus 200.

Also, unlike the Internet 600 or a mobile communications network 700, the short-distance wireless network 300 using a wireless communications scheme, such as Bluetooth, WiFi, Infrared Data Association (IrDA), or the like, allows for a direct provision of data to the mobile device 100 without data passing through an external communications device.

In other words, the Internet 600 and the mobile communications network 700 are configured to include various communications devices such as a base station, a switching system, a router, an ISP server, and the like, so when data of the portable sensor apparatus 200 is provided through the Internet 500 and the mobile communications network 700, the corresponding data is bound to be provided to the mobile device 100 through one or more communications devices. However, in the case of the short-distance wireless network 300, since the portable sensor apparatus 200 and the mobile device 100 are directly connected, the data of the portable sensor apparatus 200 can be directly provided to the mobile device 100 without passing through any communications device.

As a result, in an exemplary embodiment of the present invention, the data providing efficiency and usability of the portable sensor apparatus 200 can be maximized.

For reference, in the present exemplary embodiment, wireless communications between the portable sensor apparatus 200 and the mobile device 100 is performed through Bluetooth, WiFi, Infrared Data Association (IrDA), but any communications scheme supporting the short-distance wireless communications between the portable sensor apparatus 200 and the mobile device 100 can be applicable in an actual application case.

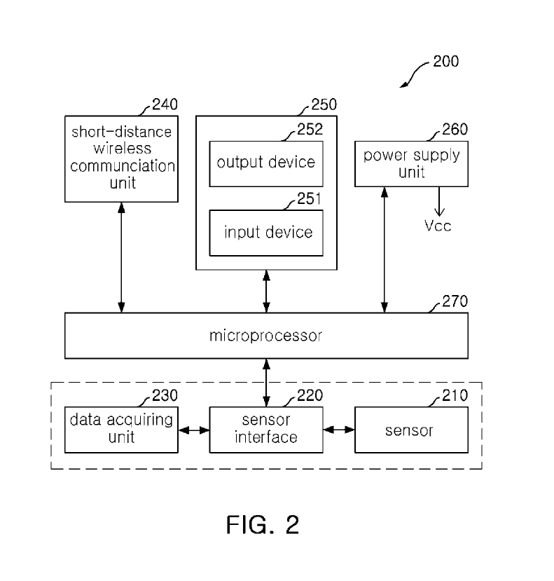

FIG. 2 is a schematic block diagram of a portable sensor apparatus according to an exemplary embodiment of the present invention.

With reference to FIG. 2, the portable sensor apparatus 200 may include a sensor 210, a sensor interface 220, a data acquiring unit 230, a short-distance wireless communications unit 240, a user interaction unit 250, a power supply unit 260, a microprocessor 270, and the like.

The sensor 210 may include an image sensor, a signal detection sensor, or the like, and acquire biometric recognition data such as a user's fingerprint, iris image, vein pattern, or the like.

The sensor interface 220 supports interfacing between the sensor 210 and the microprocessor 270. Namely, the sensor interface 220 provides an interface enabling the microprocessor 270 to recognize and control the sensor 210 and enable the sensor 210 to recognize a control command provided by the microprocessor 270.

The data acquiring unit 230 controls the driving of the sensor 210, acquires data by the sensor 210, and uniformly maintains the quality of the acquired biometric recognition data. For example, when the quality of the biometric recognition data is lower than a reference value, the data acquiring unit 230 reoperates (reactivates) the sensor 210 to reacquire the corresponding biometric recognition data.

The data acquiring unit 230 may determine the quality of the biometric recognition data by itself to perform the data reacquiring operation, or when a calculation or processing capacity of the portable sensor apparatus 200 is not sufficient, the data acquiring unit 230 may be informed of the quality of the biometric recognition data by the mobile device 100 and perform the data reacquiring operation.

The data acquiring unit 230 may perform an operation of storing the biometric recognition data just in case an operation of providing biometric recognition data because of an error generated between the mobile device 100 and the portable sensor apparatus 200.

The short-distance wireless communications unit 240 is connected to the mobile device 100 through the short-distance wireless network 300 and transmits and receives data between the portable sensor apparatus 200 and the mobile device 100.

The short-distance wireless communications unit 240 may additionally perform an encryption operation in order to stably provide the biometric recognition data to the mobile device 100. For example, the short-distance wireless communications unit 240 may encrypt both communications channel and raw data under the communications scheme such as Bluetooth, WiFi, or the like, and may encrypt the raw data under the communications scheme such as Infrared Data Association (IrDA).

The user interaction unit 250 includes an input device 251 which may be implemented as a button, a switch, a touch screen, a microphone, or the like, and an output device 252 which may be implemented as a light emitting diode (LED), a vibration element, an LCD, a speaker, and the like. The user interaction unit 250 receives various user requests (e.g., a request for acquiring biometric recognition data, a request for activating/deactivating the portable sensor apparatus, a request for displaying the biometric recognition data, and the like) through the input device 251, and informs the user regarding various operational states (e.g., a current operation performing stage or a charged state of or a battery or remaining capacity of the battery) of the portable sensor apparatus 200 through the output device 252.

The power supply unit 260 supplies driving power of the portable sensor apparatus 200. Also, the power supply unit 260 may perform an operation of charging driving power or an operation of notifying about charged/discharged amount of driving power, as necessary.

The microprocessor 270 may perform or process commands such as an operational procedure, operational conditions, and the like, of the portable sensor apparatus 200, and processes commands for integratedly and collectively managing operations of the all the elements in the portable sensor apparatus 200 based on the same.

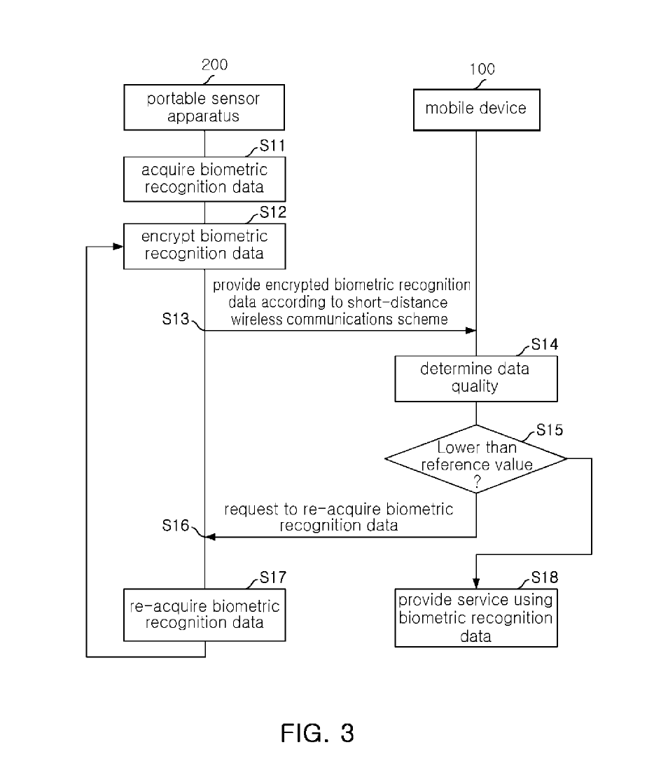

FIG. 3 is a flow chart illustrating the process of a method for providing biometric recognition data using a short-distance wireless network according to an exemplary embodiment of the present invention. Hereinafter, the mobile device 100 performs an operation of analyzing data quality for the sake of brevity.

When the sensor 210 acquires biometric recognition data such as a user's fingerprint, iris image, vein pattern, or the like, the sensor interface 220 converts the acquired biometric recognition data into a data format which can be processed by the microprocessor 270 (step S11).

The microprocessor 270 commands the short-distance wireless communications unit 240 to transmit data to the mobile device 100, and the short-distance wireless communications unit 240 encrypts the biometric recognition data acquired by the sensor 210 (step S12), and provides the encrypted biometric recognition data to the mobile device 100 according to a short-distance wireless communications scheme (step S13).

Namely, the microprocessor 270 processes the data transmission command, and the short-distance wireless communications unit 240 encrypts the biometric recognition data (step S12) and provides the encrypted biometric recognition data to the mobile device 100 according to the short-distance wireless communications scheme, such as Bluetooth, WiFi, Infrared Data Association (IrDA) (step S13).

Upon receiving the encrypted biometric recognition data, the mobile device 100 decrypts the biometric recognition data and determines the quality of the biometric recognition data (step S14).

When the quality of the biometric recognition data is lower than a reference value (step S15), the mobile device 100 determines that it cannot provide a service required by the user by using the currently received biometric recognition data, and requests reacquisition of the biometric recognition data from the portable sensor apparatus 200 (step S160).

In response thereto, the portable sensor apparatus 200 reacquires the biometric recognition data requested by the mobile device 100 through the data acquiring unit 230 (step S17), and re-enters the step S12 in order to provide re-acquired biometric recognition data to the mobile device 100 once more.

Meanwhile, when the quality of the biometric recognition data is higher than the reference value (step S15), the mobile device 100 immediately provides the service required by the user by using the currently received biometric recognition data (step S18).

As set forth above, according to exemplary embodiments of the invention, the independent portable sensor apparatus having a wireless transmission function and the biometric recognition-based service system having the same allow a mobile device to stably receive data required for an application program through a short-distance wireless network without having to change the existing structure or size of the mobile device. Thus, an application can be effectively implemented through a cooperative operation between the mobile device and the portable sensor apparatus. For example, fingerprint data acquired by the portable sensor apparatus including a fingerprint recognition sensor can be transmitted to the mobile device such as a smartphone through a short-distance wireless network, so the smartphone can conveniently obtain the biometric recognition data by simply installing an application program, without changing an existing structure of the smartphone, to develop a service system. This principle can be applicable to various bio/medical data acquiring sensor apparatuses, as well as the portable sensor apparatus which acquires and provides biometric recognition data, greatly contributing to effective development of application services by the medium of mobile devices.

In addition, since the portable sensor apparatus can directly provide data required by the mobile device through the short-distance wireless network, it can have a relatively small communications capacity and a fast response speed.

While the present invention has been shown and described in connection with the exemplary embodiments, it will be apparent to those skilled in the art that modifications and variations can be made without departing from the spirit and scope of the invention as defined by the appended claims.

What is claimed is:

1. A portable sensor apparatus interworking with a mobile device through a short-distance wireless network, the apparatus comprising:
a sensor unit acquiring biometric recognition data;
a short-distance wireless communications unit providing the biometric recognition data to the mobile device through the short-distance wireless network or receiving a request from the mobile device;
a microprocessor commanding acquisition of the biometric recognition data in response to a request from the mobile device or a user request; and
a user interaction unit receiving the user request or displaying an operational state of the portable sensor apparatus.

2. The apparatus of claim 1, wherein the short-distance wireless network uses a communications scheme, such as Bluetooth, WiFi, and Infrared Data Association (IrDA).

3. The apparatus of claim 2, wherein when a Bluetooth or a WiFi communications scheme is employed, the short-distance wireless communications unit encrypts both a communications channel and raw data.

4. The apparatus of claim 2, wherein when IrDA scheme is employed, the short-distance wireless communications unit encrypts the raw data.

5. The apparatus of claim 1, wherein the sensor unit comprises:
a sensor acquiring and providing biometric recognition data; and
a data acquiring unit uniformly maintaining the quality of the biometric recognition data acquired by the sensor by controlling the operation of the sensor.

6. The apparatus of claim 5, wherein the data acquiring unit further comprises a function of storing the biometric recognition data acquired by the sensor.

7. The apparatus of claim 1, further comprising: a power supply unit supplying driving power of the portable sensor apparatus and indicating a charged/discharged state of the driving power.

8. The apparatus of claim 1, wherein the user interaction unit comprises:
an input unit detecting and receiving the user request; and
an output unit informing the user about an operational state of the portable sensor apparatus.

9. A biometric recognition-based service system comprising:
a mobile device providing a service using biometric recognition data; and
a portable sensor apparatus implemented as an independent device of the mobile device, acquiring the biometric recognition data, and providing the acquired biometric recognition data to the mobile device through a short-distance wireless network.

10. The system of claim 9, wherein the short-distance wireless network uses a communications scheme, such as Bluetooth, WiFi, and Infrared Data Association (IrDA).
